(19) United States
(12) Patent Application Publication
(10) Pub. No.: US 2008/0177729 A1
(43) Pub. Date: Jul. 24, 2008

(54) Apparatus, method and computer program product for searching document

(75) Inventor: Takayuki Miyazawa, Kanagawa (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/889,707

(22) Filed: Aug. 15, 2007

(30) Foreign Application Priority Data
Sep. 28, 2006 (JP) 2006-265094

(51) Int. Cl. G06F 17/30

(52) U.S. Cl. 707/5; 707/E17.108

(57) ABSTRACT

A document searching apparatus includes a first storage unit that stores, in correspondence with one another, a normal form character, a variant form character, and rule identification information for identifying a conversion rule; a third storage unit that stores, in correspondence with one another, the normal form character, the rule identification information, document identification information, and location information of the character; an obtaining unit that obtains a input search word and a search condition that are input by a user; a first converting unit that converts the input search word to a normal-form search word; and a searching unit that performs a character search by comparing the normal-form search word and the search condition with the normal form character and the rule identification information that are brought into correspondence with each other by the third storage unit.

### CROSS-REFERENCE TO RELATED APPLICATIONS

This application is based upon and claims the benefit of priority from the prior Japanese Patent Application No. 2006-265094, filed on Sep. 28, 2006; the entire contents of which are incorporated herein by reference.

### BACKGROUND OF THE INVENTION

1. Field of the Invention

The present invention relates to a document searching apparatus, method, and computer program product for searching a registered document.

2. Description of the Related Art

A system for searching a document that includes a character string designated as a search keyword from among a set of registered documents, or a so-called full-text searching system, has been known. The methods that realize such a full-text searching system include three major methods: (1) a method with which words obtained by setting off a registered sentence every n characters are indexed (n-gram method); (2) a method with which words recognized by morphological analysis are indexed; and (3) a method with which a search is conducted directly throughout a document, without making any index.

The full-text searching system includes a function called a variant search. This is to reduce possibilities of omission of any word from the search, and the search is executed without differentiating notational variants covered by a search keyword, such as upper-case/lower-case alphabets and old/new styles of Kanji character.

A technique of executing such a variant search by adopting the n-gram method has been known. For instance, JP-A 2003-228579 (KOKAI) suggests that, as a variant search technique adopting both n-gram index and morphological index, entries are stored in the morphological index by use of a normalized form, while for the n-gram index, variant expansion is available at the time of search.

JP-A 2004-199282 (KOKAI) teaches that code numbers are assigned to variant characters of the group variants and the normal form group, and an inverted index is prepared for each group. When a variant search is incorporated into the search, the inverted index is looked up by use of the code numbers of the normal forms. When a variant search is not incorporated, the inverted index is looked up by use of the code numbers of the variant forms. Whether to conduct a variant search during a search is designated in this manner.

Techniques of conducting a variant search with the n-gram method includes storing entries by normalizing characters when building an index, registering both original forms and normal forms with the index, and conducting a search while providing possible expanded forms.

If characters are normalized at the time of storing, information from the index is not enough to conduct a search for an exact match. Thus, the system control needs to go back to check the notational form of the original document. If forms are expanded during a search, the index needs to be looked up so many times for the expanded forms and the index search results for so many forms have to be merged together that the processing speed slows down.

On the other hand, there is demand for a system in which search conditions can be designated in accordance with users' needs, such as a search during which various variants are considered as an identical character or differentiated from one another.

### SUMMARY OF THE INVENTION

According to one aspect of the present invention, a document searching apparatus includes a first storage unit that stores, in correspondence with one another, a normal form character which is a character of a normal form that is a predetermined notational form, a variant form character which is a character of a notational form different from the normal form, and rule identification information that is used to identify a conversion rule applied to conversion of the variant form character to the normal form character; a second storage unit that stores a document that is a search target; a third storage unit that stores, in correspondence with one another, the normal form character corresponding to a character included in the document stored in the second storage unit, the rule identification information, document identification information that is used to identify the document, and location information of the character included in the document; a first obtaining unit that obtains a input search word input by a user; a second obtaining unit that obtains a search condition relating to a notational form of the input search word; a first converting unit that converts the input search word to a normal-form search word based on the normal form character and the variant form character that are brought into correspondence by the first storage unit; and a searching unit that searches the character in the document by comparing the normal-form search word and the search condition with the normal form character and the rule identification information, respectively, which are brought into correspondence by the third storage unit.

According to another aspect of the present invention, a document searching apparatus includes an obtaining unit that obtains a plurality of conversion rules that are used for conversion of a notational form of a character; a first converting unit that converts a variant form character, which is a character of a different form from a normal form that is a predetermined notational form, to a normal form character which is a character of the normal form in accordance with the conversion rules obtained by the obtaining unit; a first storage unit that stores, in correspondence with one another, the variant form character, the normal form character, and rule identification information that is used to identify the conversion rules applied to the conversion to the normal form character; a second storage unit that stores a document that is a search target; a dividing unit that divides the document stored by the second storage unit and obtains a character; a second converting unit that converts the character obtained by the dividing unit to the normal form character in accordance with the variant form character and the normal form character that are brought into correspondence with each other by the first storage unit; and a third storage unit that stores, in correspondence with one another the normal form character obtained by the second converting unit, the rule identification information, document identification information that is used to identify the document, and location information of the character.

According to still another aspect of the present invention, a document searching method includes obtaining a search word input by a user; obtaining a input search word input by a user; obtaining a search condition relating to a notational form of the input search word; converting the input search word to a normal-form search word which is a word of a normal form that is a predetermined notational form, based on a normal form character which is a character of the normal form and a variant form character which is a character of a notational form different from the normal form, that are brought into correspondence by a first storage unit that stores, in correspondence with one another the normal form character, the variant form character, and rule identification information that is used to identify a conversion rule applied to conversion of the variant form character to the normal form character; and comparing the normal form character and the rule identification information that are brought into correspondence by a second storage unit with the normal-form search word and the search condition, respectively, that are obtained in a converting, the second storage unit storing, in correspondence with one another, the normal form character that corresponds to a character included in a search target document, the rule identification information, document identification information that is used to identify the search target document, and location information of the character included in the search target document, and thereby searching the character in the search target document.

According to still another aspect of the present invention, a document searching method includes obtaining a plurality of conversion rules that are used to convert a notational form of a character; converting a variant form character which is a character of a notational form different from a normal form that is a predetermined notational form, to a normal form character which is a character of the normal form based on the conversion rules; registering with a first storage unit, in correspondence with one another the variant form character, the normal form character, rule identification information that identifies the conversion rules that are used for conversion to the normal form character in the converting; registering a search target document with a second storage unit; dividing the search target document stored by the second storage unit to obtain a character; converting the character to the normal form character, based on the variant form character and the normal form character that are brought into correspondence by the first storage unit; and registering with a third storage unit, in correspondence with one another, the normal form character, the rule identification information, document identification information of the search target document, and location information of the characters included in the search target document.

A computer program product according to still another aspect of the present invention causes a computer to perform the methods according to the present invention.

### BRIEF DESCRIPTION OF THE DRAWINGS

FIG. 1 is a block diagram of a functional structure of a document searching apparatus;

FIG. 2 is a diagram for explaining conversion rules obtained by a conversion rule managing unit;

FIG. 3 is a schematic diagram of a data structure of normalization information stored in a normalization information storage unit.

FIG. 4 is a schematic diagram of a data structure in a document storage unit;

FIG. 5 is a schematic diagram of a data structure in an n-gram index storage unit;

FIG. 6 is a diagram for explaining search character strings, form search conditions, normal-form search character strings, and rule search conditions;

FIG. 7 is a flowchart of a normalization information registering process conducted by the document searching apparatus;

FIG. 8 is a diagram of a data structure of a conversion rule setting file obtained by the conversion rule managing unit;

FIG. 9 is a diagram of normalization information generated in the processes at steps S100 to S107;

FIG. 10 is a flowchart of a document registering process performed by the document searching apparatus;

FIG. 11 is a flowchart of a document searching process performed by the document searching apparatus; and

FIG. 12 is a diagram of a hardware configuration of the document searching apparatus.

### DETAILED DESCRIPTION OF THE INVENTION

Exemplary embodiments of an apparatus, a method, and a computer program product for searching document according to the present invention are explained in detail below with reference to the drawing. The present invention should not be limited to these embodiments, however.

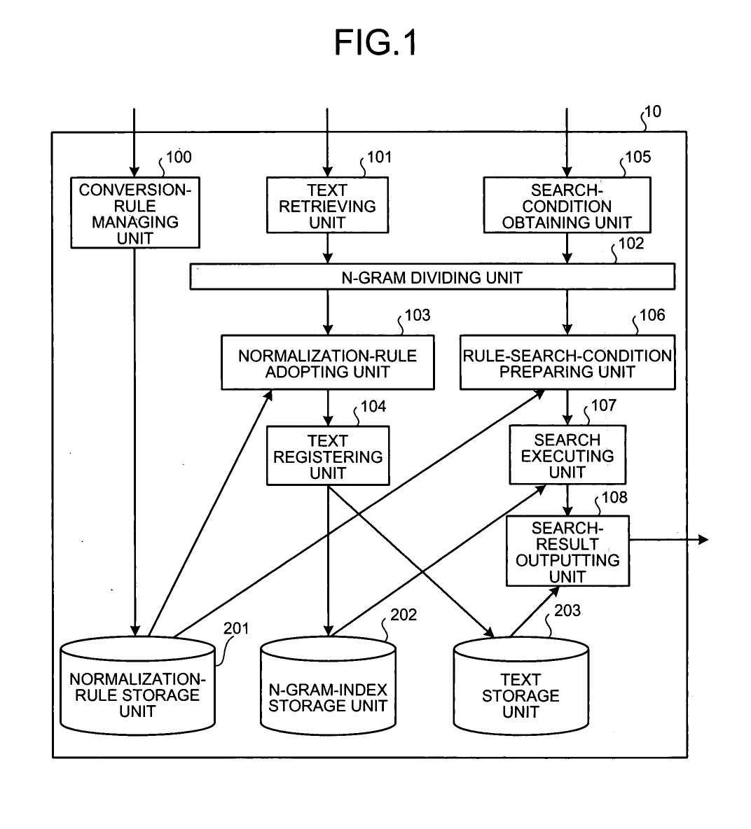

As illustrated in FIG. 1, a document searching apparatus 10 according to an embodiment includes a conversion-rule managing unit 100, a document retrieving unit 101, an n-gram dividing unit 102, a normalization-rule adopting unit 103, a document registering unit 104, a search-condition obtaining unit 105, a rule-search-condition preparing unit 106, a search executing unit 107, a search-result outputting unit 108, a normalization-rule storage unit 201, an n-gram-index storage unit 202, and a document storage unit 203.

The conversion-rule managing unit 100 obtains conversion rules. The conversion rules indicate rules that are used to convert a character of a certain form to the character of a different form. For instance, the conversion rules include a rule for converting “ [symbol] ” (old-style Kanji) to a different character style “ [symbol] ” (new-style Kanji). The characters include numerals. The subject of conversion is widely applicable to anything for which variant forms are available.

With the conversion rules, characters of various forms can be converted to characters of a normal form. The normal form indicates a standard notation for the search process performed by the document searching apparatus 10. Any other forms are referred to as variants.

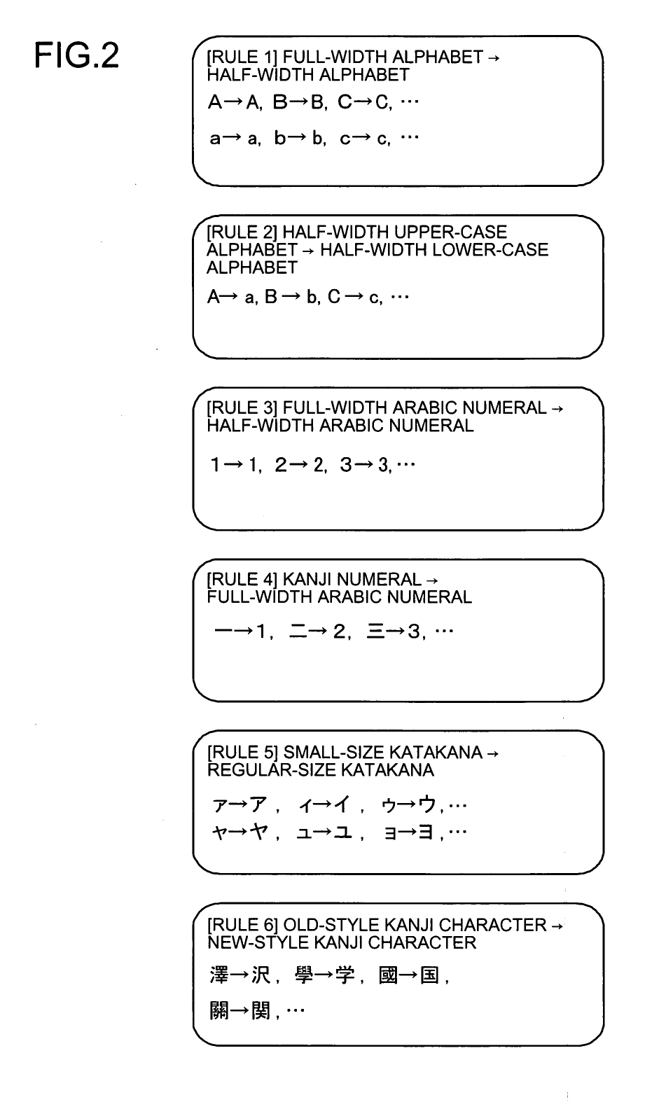

FIG. 2 is a diagram of conversion rules including Rules 1 to 6. Rule 1 is a conversion rule for converting a full-width alphabet to a half-width alphabet. Rule 2 is a conversion rule for converting a half-width upper-case alphabet to a half-width lower-case alphabet. Rule 3 is a conversion rule for converting a full-width Arabic numeral to a half-width Arabic numeral. Rule 4 is a conversion rule for converting a Kanji numeral to a full-width Arabic numeral. Rule 5 is a conversion rule for converting a small-size Katakana character to a regular-size Katakana character. Rule 6 is a conversion rule for converting an old-style Kanji character to a new-style Kanji character. In each rule, the characters before and after the conversion establish one-to-one correspondence.

Both Rules 1 and 2 relate to conversion of the same character “A”, but are different conversion rules. The conversion rules obtained by the conversion-rule managing unit 100 include different conversion rules for the same character.

In addition, the conversion rules obtained by the conversion-rule managing unit 100 include rules for not only converting a variant to a normal form but also converting a variant to another variant. For instance, the normal form for alphabets is a half-width lower-case form. Rule 1 indicated in FIG. 2 relates to conversion of a full-width upper-case alphabet to a half-width upper-case alphabet. In other words, it is a conversion rule for converting a certain variant form to another variant form. By incorporating conversion to a different variant form into the system, the variety of search is expanded. The details will be given below.

The conversion-rule managing unit 100 also creates normalization information based on the conversion rules and stores it in the n-gram-index storage unit 202. The normalization information represents a table that is looked up when converting a variant of a character to its normal form.

For example, when the full-width upper-case alphabet “A” is to be converted to the half-width lower-case alphabet “a”, Rules 1 and 2 are followed. Thus, the variant “A (full-width)” and normal form “a (half-width)” are brought into correspondence with Rules 1 and 2 and registered as normalization information.

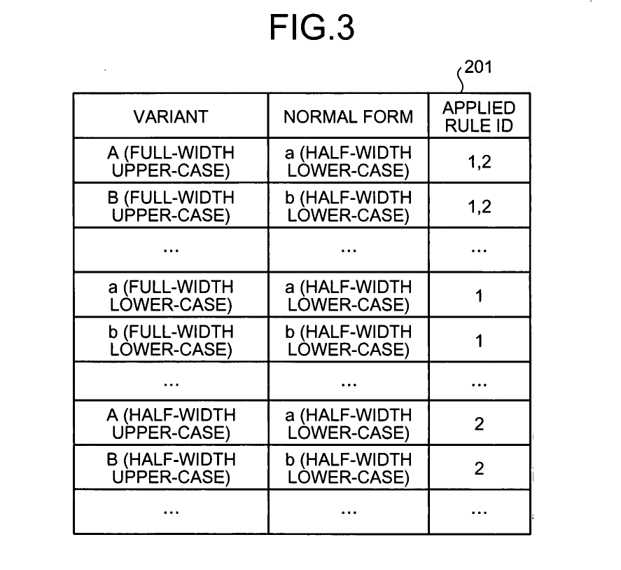

As described in FIG. 3, the normalization information includes variants, normal forms, and IDs of adopted rules in correspondence with one another. The IDs of adopted rules means IDs of the conversion rules that are followed in conversion from a variant to a normal form.

The explanation returns to FIG. 1. The document retrieving unit 101 obtains a document that is to be searched through. The n-gram dividing unit 102 divides the document into n-grams, which are document character strings. An n-gram is a string of n characters, or one of strings divided every n characters (hereinafter, “gram”). In the n-gram division, a character string is divided into several character strings, with the strings at the beginning and at the end having less than n characters. For instance, when n=3, a character string [symbol] (XML document) is divided into 11 grams; “X”, “XM”, “XML”, [symbol] , [symbol] , “ [symbol] and

[symbol]

The normalization-rule adopting unit 103 checks whether any of the grams obtained by the n-gram dividing unit 102 includes a notational form that is to be subjected to normalization. In other words, the normalization-rule adopting unit 103 detects variant forms. When a variant is detected, the variant is converted to the normal form by referring to the normalization-rule storage unit 201. For instance, when “a (full-width)” is detected, the normalization-rule storage unit 201 detects “a (full-width)” from among its data and converts it to the normal form “a (half-width)” with which the variant is brought into correspondence. Furthermore, the normalization-rule storage unit 201 finds the ID of the rule with which “a (half-width)” is brought into correspondence.

When a gram includes more than one character, the rule ID is identified for each character. If more than one rule is to be followed for the conversion to normal form, the corresponding IDs of the conversion rules are identified.

For example, when a gram “XML (all full-width)” is to be subjected to conversion, the above process is conducted on each of the characters. More specifically, the normalization-rule storage unit 201 detects the normal form “x (half-width)” and the rule IDs 1 and 2 in correspondence with “X (full-width)”. In a similar manner, the normal form “m (half-width)” and the rule IDs 1 and 2 are detected in correspondence with “M (full-width)”, and the normal form “l (half-width)” and the rule IDs 1 and 2 are detected in correspondence with “L (full-width)”. The normalization-rule adopting unit 103 serves as a document character string converting unit.

The document registering unit 104 registers the document retrieved by the document retrieving unit 101 with the document storage unit 203. The document registering unit 104 also registers an n-gram index, which is an inverted index for a document, with the n-gram-index storage unit 202. The inverted index represents an index that is employed to determine the location of the document that includes a corresponding character in a character string obtained as a search condition.

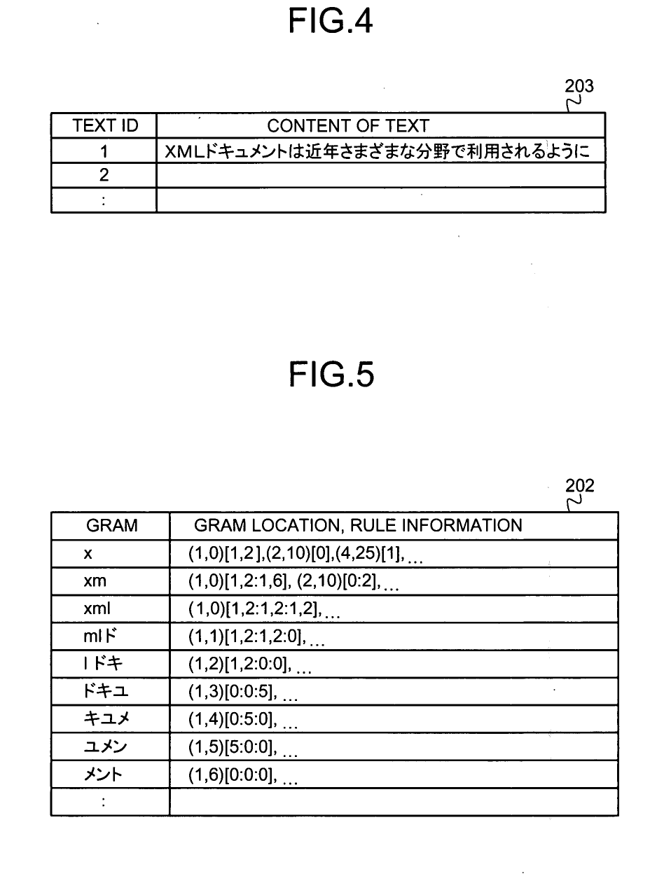

As shown in FIG. 4, the document storage unit 203 stores therein documents and document IDs for identifying the documents in correspondence with each other. FIG. 5 is a schematic diagram for the data structure of the n-gram-index storage unit 202. The n-gram-index storage unit 202 stores therein the normal form of a gram, the location thereof, and rule information in correspondence with one another. The location of a gram includes the ID of a document that contains the gram, and the offset of the document. The offset refers to a distance from the beginning of the document. The rule information includes information for determining each character in the gram and the rule IDs used when normalizing the characters.

In FIG. 5, the location of the gram is indicated in parentheses, and the rule information is indicated in brackets. For instance, (1, 0) and [1, 2] are brought into correspondence with the gram “x”. (1, 0) indicates that the document ID is “1” and the offset is “0”. More specifically, “x” is placed at the beginning of the document of the document ID 1.

Moreover, [1, 2] indicates that the conversion rules that are followed when normalizing the character to “x” are Rules 1 and 2. This indicates that “x” has been originally placed as “X (full-width)” in the document. As this example shows, the notational form actually used in the document can be identified from the rule information.

The gram “ml [symbol] is brought into correspondence with rule information [1, 2:1, 2:0]. The rule IDs corresponding to individual characters in the gram are separated by colon “:”. The numerals placed before the first colon represents the rule IDs that are adopted for the first character of the gram. The numerals between the first and second colons represent rule IDs adopted for the second character of the gram.

For example, the character “m” in the gram is brought into correspondence with Rules 1 and 2. The character “l” in the gram is also brought into correspondence with Rules 1 and 2. The character “ [symbol] in the gram is brought into correspondence with 0, which indicates that no rule is applied. As shown in this example, the rule IDs for each character in a gram are stored in such a manner that the corresponding character is identifiable.

The rule information may be expressed as bit strings. For instance, when there are five normalization rules and a 3-gram index is to be built, rule IDs for each character can be expressed in 3×5=15 bits. The storage area for the rule information can be thereby reduced.

When conversion rules vary in accordance with the types of characters such as numerals and alphabets, as the conversion rules according to the embodiment, information for distinguishing the types of characters may be used so that the number of bits required can be reduced. For instance, according to the embodiment, Rules 1 and 2 are applied only to alphabets. Rules 3 and 4 are applied only to numerals. Rule 5 is applied only to Katakana characters, while Rule 6 is applied only to Kanji characters. In short, there are three different types of characters, and two rules at maximum are adopted for a type of character. Hence, the conversion rules to be applied can be expressed with two more bits in addition to bits for the character type information. In this case, the rule IDs for each character can be expressed in 2×3=6 bits.

The explanation returns to FIG. 1 again. The search-condition obtaining unit 105 obtains a search character string and a form search condition. The form search condition is a search condition in relation to notational forms, which includes “exact matching” specifying a search for an item whose notational form matches that of the search character string, and “case- and width-insensitive” specifying a search that does not place a limit on any notational form of the search character string.

When “exact matching” is selected, the search condition is that, if the obtained search character string is “x (full-width)”, for example, “x” in lowercase and full width should be searched for, and that “x” in uppercase or half width should be considered as a different character. When “case- and width-independent” is selected, the search condition is that, if the obtained search character string is “x (full-width)”, for example, not only the full-width lower-case “x” but also full-width upper-case, half-width upper-case, and half-width lower-case “x” should be searched for.

The search character string is divided into grams by the n-gram dividing unit 102, and the grams are sent to the rule-search-condition preparing unit 106. In other words, the n-gram dividing unit 102 according to the embodiment serves as a search word dividing unit.

The rule-search-condition preparing unit 106 converts each character in a gram into the normal form that is stored in the normalization-rule storage unit 201 as a form with which the character is brought into correspondence. The rule-search-condition preparing unit 106 also obtains a notation search condition, based on which the rule-search-condition preparing unit 106 generates a rule search condition. The rule search condition is a calculation method with which the inverted index stored in the n-gram-index storage unit 202 is used. More specifically, it represents information on rule IDs applied when searching a notational form that satisfies the notation search condition. In other words, the rule-search-condition preparing unit 106 according to the embodiment serves as a post-search notation converting unit.

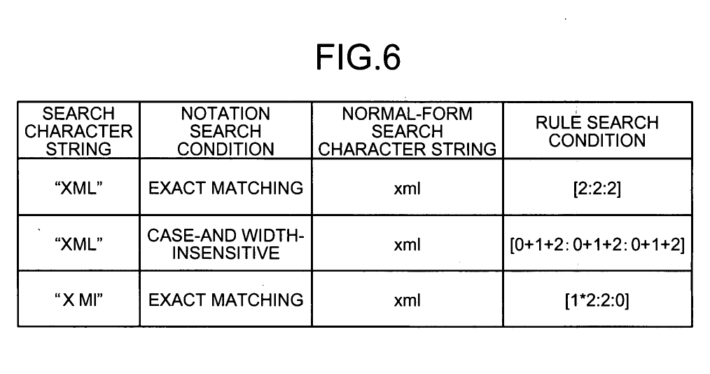

As shown in FIG. 6, it is supposed that the search character string is “XML (half-width X, M, and L)” and that the notation search condition is exact matching. In this case, the rule-search-condition preparing unit 106 normalizes each character in the search character string, thereby obtaining a normalized search character string “xml (half-width x, m, and l)”.

The rule-search-condition preparing unit 106 further generates a rule search condition from the notation search condition “exact matching”. More specifically, the rule-search-condition preparing unit 106 determines the conversion rules used for the normalization of the search character string as a rule search condition. The combination of each character in the search character string “XML (half-width X, M, and L)” and the corresponding characters in the normalized search character string “xml (half-width x, m, and l)” is brought into correspondence with Rule 2 according to the data in the normalization-rule storage unit 201. Thus, the rule search condition [2:2:2] (only Rule 2 being applied to all the characters) is generated.

As another example, it is supposed that the search character string is “XML (half-width X, M, and L)” and that the notation search condition is case- and width-insensitive. Then, the rule-search-condition preparing unit 106 normalizes the search character string to obtain a normalized search character string “xml (half-width x, m, and l)”.

Further, a rule search condition is generated from the notation search condition “case- and width-insensitive”. When “case- and width-insensitive” is selected, a rule search condition that all the conversion rules related to alphabets are applied is generated. In the example described in FIG. 2, Rules 1 and 2 are alphabet-related conversion rules. These rules are to be applied. A case of no rule applied should also be included. In other words, a character string in normal form should equally be a search target.

Hence, the rule search conditions generated for the above case are the normalized search character string being “xml (half-width x, m, and l)” and [0+1+2:0+1+2:0+1+2] (no rule applied to all characters or Rule 1 applied or Rule 2 applied).

Now, it is supposed that the search character string is “XMl (full-width X, half-width M, and half-width l), and that the notation search condition is “exact matching”. Then, the rule-search-condition preparing unit 106 normalizes the search character string to obtain a normalized search character string “xml (half-width x, m, and l)”.

Furthermore, a rule search condition is generated from the notation search condition “exact matching”. The normalization conversion of “X” is from a full-width upper-case alphabet to a half-width lower-case alphabet. This means that Rules 1 and 2 indicated in FIG. 2 are applied. The normalization conversion of “M” is from a half-width upper-case alphabet to a half-width lower-case alphabet. This means that Rule 2 is applied. The normalization conversion of “l” means a conversion to a half-width lower-case alphabet, which is the normal form. Thus, no conversion rule is applied.

The rule search conditions are thereby generated, including the normalized search character string being “xml (half-width x, m, and l)” and the search notation condition [1*2:2:0] (Rules 1 and 2 applied to the first character, Rule 2 applied to the second character, and no rule applied to the third character).

The rule IDs that serve as search conditions for each character are determined, based on the notation conditions designated by the user. Furthermore, a search targeted for half-width characters only or for both half- and full-width characters, for example, can be realized by designating notation forms that are to be incorporated into the search by use of designation of conversion rules of the notational forms.

According to the embodiment, the rule IDs are determined from the designation of “exact matching” or “case- and width-insensitive”. However, the embodiment is not limited thereto, and information obtained from the user will suffice as long as it can be employed to determine rule IDs.

The search executing unit 107 searches for a character string that satisfies the rule search conditions, based on the normalized search character string and the rule search conditions that are obtained by the rule-search-condition preparing unit 106 by use of the inverted index stored in the n-gram-index storage unit 202. The search-result outputting unit 108 receives a search result from the search executing unit 107, extracts the corresponding document from the normalization-rule storage unit 201, and output the document.

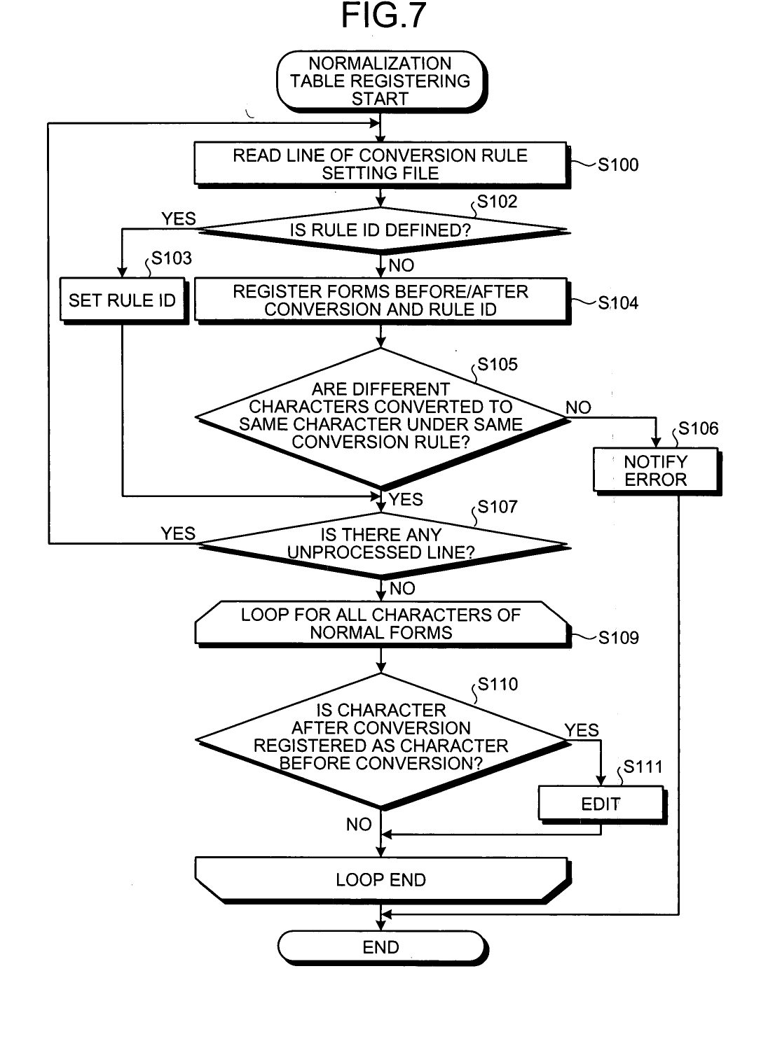

In the normalization information registering process as shown in FIG. 7, first, the conversion-rule managing unit 100 reads therein a conversion rule setting file on which conversion rules are listed (step S100).

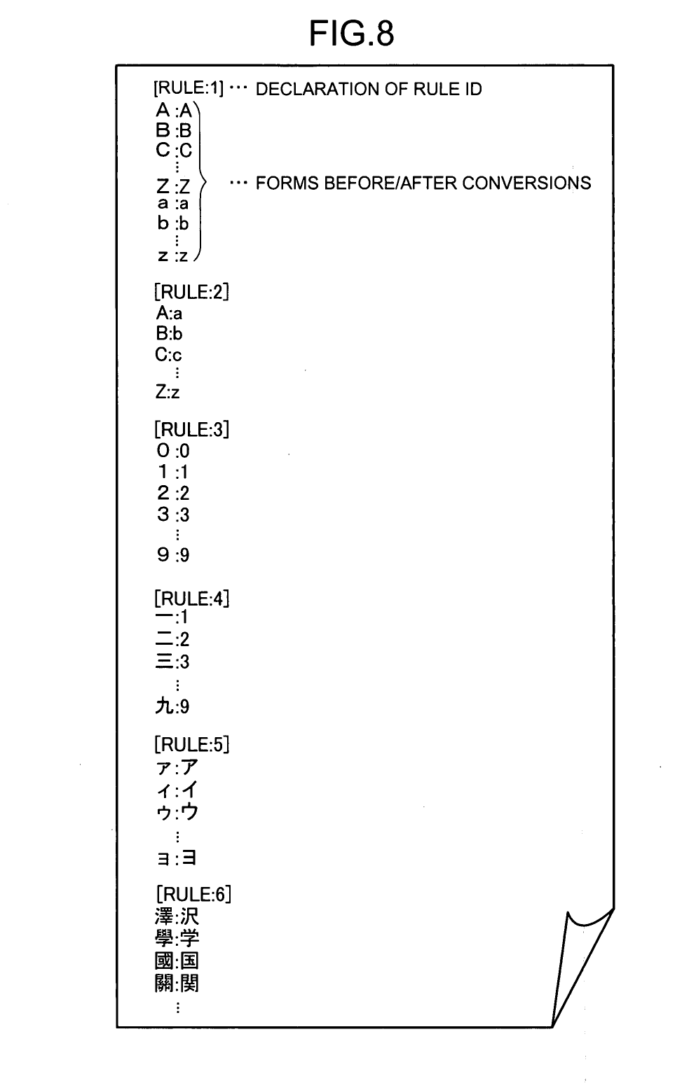

As shown in FIG. 8, the conversion-rule setting file includes rule IDs and notational forms before and after the conversion according to the rule of each rule ID. The forms before and after the conversion are provided on the left and right sides, respectively, of “:”.

The conversion-rule managing unit 100 reads therein the conversion rule setting file line by line. When the content of a line that is read in is the declaration of a rule ID (yes at step S102), the rule ID is set to the declared value (step S103). The system control proceeds to step S106. For instance, in the conversion rule setting file shown in FIG. 8, the line presenting [rule: 1] is a declaration line of the rule ID.

On the other hand, the content of a line that is read in is notational forms before and after the conversion, the combinations of the notational forms before and after the conversion and the rule ID are brought into correspondence with each other, and stored in the normalization-rule storage unit 201 (step S104). Next, the notational form after the conversion is checked to see whether it is the same as the form after a conversion conducted on a different form in accordance with the same conversion rule. In other words, it is to check whether different characters are converted into the same character under the same conversion rule.

If different characters are converted into the same character (yes at step S105), a notification of an error is sent (step S106), and the process is completed.

On the other hand, if there are no different characters converted into the same character (no at step S105), and if there is any unprocessed line (yes at step S107), the system control goes back to step S100 to process the next line (step S100 to 105). With the above process, a pair of notational forms before and after the conversion and the rule ID of a rule to be applied are brought into correspondence with each other for all the characters included in the rules.

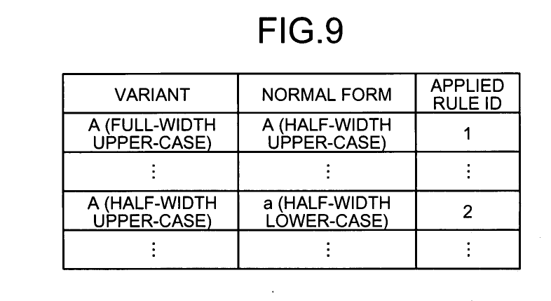

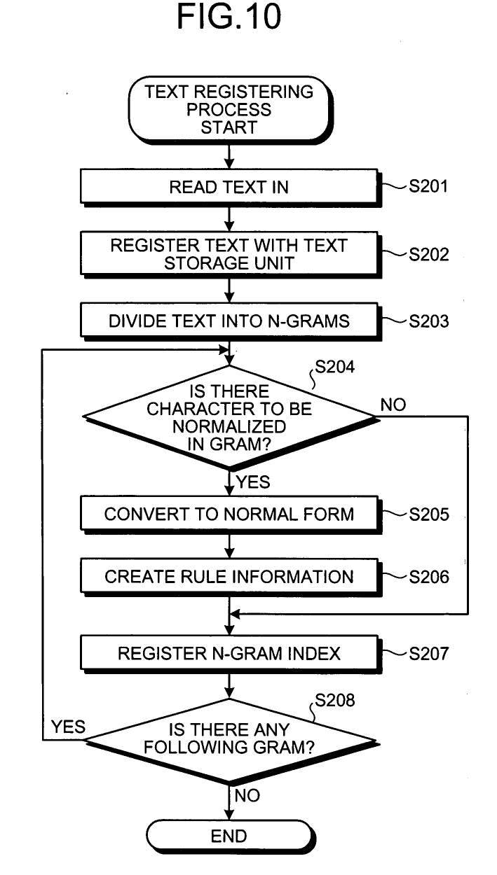

For instance, according to the normalization information provided in FIG. 9, “A (half-width)” is a character after a conversion under Rule 1 and also a character before a conversion under Rule 2. When a character after a conversion under the first conversion rule matches a character before a conversion under the second conversion rule (yes at step S110), further manipulation is conducted (step S111) because the converted character is not yet in the normal form.

More specifically, the character before the conversion under the first conversion rule is registered as a variant and brought into correspondence with 1 as an applied rule ID, while the character after the conversion under the second conversion rule is registered as a normal form and brought into correspondence with 2 as an applied rule ID. In the example shown in FIG. 9, “A (full-width)” is registered as a variant and brought into correspondence with 1 as an applied rule ID, while “a (half-width)” is registered as a normal form and brought into correspondence with 2 as an applied rule ID. The same procedure is followed for every character registered as the normalization information, and then the normalization rule table registering process is completed.

At step S111, when a character after a conversion under the first conversion rule matches a character before a conversion under the second conversion rule, and when a character after the conversion under the second conversion rule matches a character before the conversion under the first conversion rule, notification of an error is sent out to terminate the process because a circular definition occurs in the conversion rules.

The normalization information should be prepared before registering the document. When a new item is added to the normalization information, the index stored in the n-gram-index storage unit 202 has to be recreated for all the characters of all the notational forms in the added item.

In the document registering process as indicated in FIG. 10, first, the document retrieving unit 101 reads therein a document (step S201). Next, the document registering unit 104 registers the document read by the document retrieving unit 101 with the document storage unit 203 (step S202). Then, the n-gram dividing unit 102 divides the document into n-grams (step S203). When a character that is to be normalized, or in other words a variant, is included in a gram (yes at step S204), the character is converted to the normal form by use of the normalization-rule storage unit 201 as a reference (step S205). Rule information including rule IDs of conversion rules that are used for the normalization is prepared (step S206).

Next, the gram of the normal form, the gram location, and the rule information are brought into correspondence with one another and registered with the n-gram-index storage unit 202 (step S207). After the process at step S204 thorough step S207 is repeated for all the grams in the document (no at step S208), the document registering process is completed.

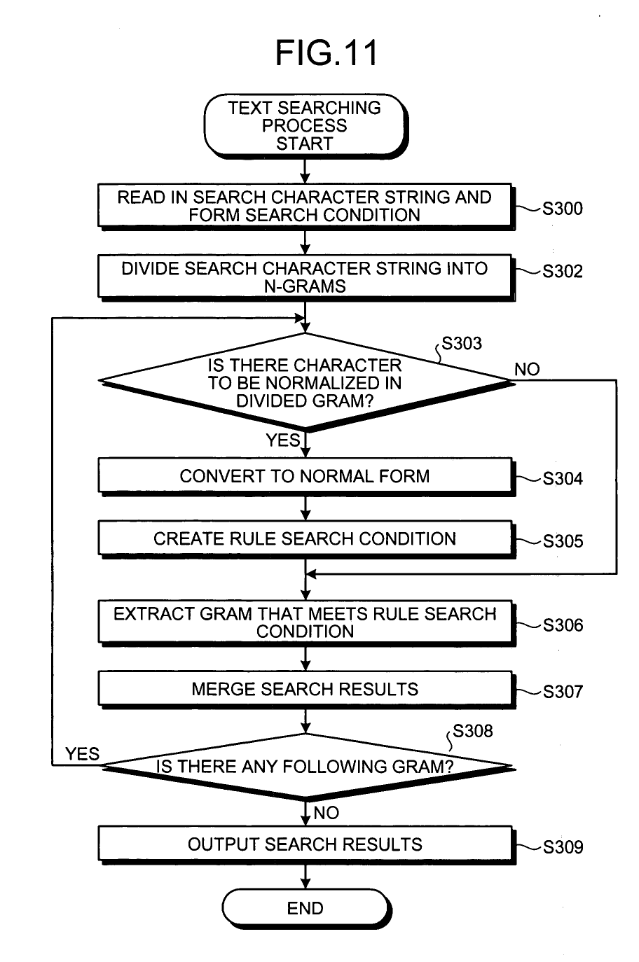

In a document searching process, as indicated in FIG. 11, first, the rule-search-condition preparing unit 106 reads therein a search character string and a notation search condition (step S300). Next, the n-gram dividing unit 102 divides the search character string into n-grams (step S302). When there is a character to be normalized in a gram, or in other words when there is a variant in the gram (yes at step S303), the character is converted to the normal form by referring to the normalization-rule storage unit 201 (step S304). Furthermore, a rule search condition is prepared, based on the notation search condition and the conversion rule used for the normalization (step S305).

Next, the search executing unit 107 extracts a gram that satisfies the rule search condition from the n-gram-index storage unit 202 (step S306). Then, the search result is merged together (step S307). More specifically, if the search character string is, for example, a “XML document”, all the grams that correspond to any offset satisfying the array of the search character string are extracted. The process at steps S303 through S307 is repeated for all the grams in the search character string (no at step S308), the search-result outputting unit 108 outputs the search result (step S309). Then, the document searching process is completed.

The document searching apparatus 10 according to the embodiment defines conversion rules in advance, and stores the normal form of a gram, the gram position, and the rule information in the n-gram-index storage unit 202 when registering a document. Hence, a search can be conducted by comparing the normal form of the gram with the normal form of the search character string and also comparing the rule search condition with the rule information.

In addition, because multiple conversion rules are defined to meet various search conditions on notational forms, a search can be conducted under some of the rules, with forms limited as desired. Conversion of a character of a certain form can be realized under a condition that the character should be considered different from or the same as the character of a different form. By configuring the conversion-rule managing unit 100 to read conversion rules therein, even a detailed search requires only a short time.

For instance, some of the conventional systems independently store half- and full-width alphabets of upper and lower cases and half- and full-width numerals in advance. In such a case, the registered document needs to be consulted if the search should be width-insensitive for numerals but width-sensitive for alphabets, or if the search should be case-insensitive and width-sensitive for alphabets.

In contrast, the document searching apparatus 10 according to the embodiment can obtain search results only by referring to normal forms and adopted rule IDs even in a search as described above. Thus, the registered document needs not be consulted, which results in a high-speed search.

Other conventional systems store a document as originally input and expand the notational forms at the time of search. For a search of this type, a process of looking up multiple indexes in accordance with types of variants included in a target gram and merging the results is required. For instance, in a width- and case-insensitive search, four different expanded forms are conceivable for every alphabetic character. If an index is built with 3-grams, 43=64 types of grams should be looked up on the index. If the number of grams increases, the search results of these grams need to be merged accordingly. This increases a volume of calculation, slows down the search, and takes up more memory space for the merge.

In contrast, the document searching apparatus 10 according to the embodiment merely looks up a normal-form gram stored in the n-gram-index storage unit 202 and performs filtering based on the rule information to obtain a search result. The document searching apparatus 10 can thereby reduce the number of accesses to the n-gram index, a memory space required as an intermediate buffer, and a volume of calculation for merging.

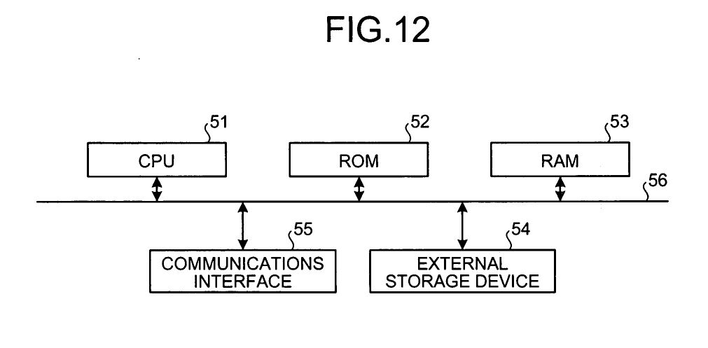

As illustrated in FIG. 12, the document searching apparatus 10 includes, as a hardware configuration, a ROM 52 that stores therein document searching programs that conduct a document searching process on the document searching apparatus 10 and the like; a CPU 51 that controls all the units of the document searching apparatus 10 in accordance with the programs stored in the ROM 52; an external storage device 54 that stores therein information stored in the normalization-rule storage unit 201, the n-gram-index storage unit 202, and the document storage unit 203; a RAM 53 that stores therein various kinds to data necessary for the control of the document searching apparatus 10 and information read from the external storage device 54; a communications interface 55 that performs communications through networks; and a bus 56 that connects the units to one another.

The document searching programs of the document searching apparatus 10 may be stored as installable or executable files in a computer-readable recording medium such as a CD-ROM, a floppy disk (registered trademark), and a DVD.

If this is the case, a document searching program will be read from the recording medium and executed on the document searching apparatus 10 so that the program will be loaded on the main storage device to establish each unit thereon, as explained in the description of the software configuration.

Otherwise, the document searching program according to the embodiment may be stored on a computer connected to a network such as the Internet, and configured to be downloadable through the network.

The present invention has been explained in accordance with the embodiment. However, various modifications and improvements may be added to the embodiment as necessary.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A document searching apparatus comprising:
a first storage unit that stores, in correspondence with one another, a normal form character which is a character of a normal form that is a predetermined notational form, a variant form character which is a character of a notational form different from the normal form, and rule identification information that is used to identify a conversion rule applied to conversion of the variant form character to the normal form character;
a second storage unit that stores a document that is a search target;
a third storage unit that stores, in correspondence with one another, the normal form character corresponding to a character included in the document stored in the second storage unit, the rule identification information, document identification information that is used to identify the document, and location information of the character included in the document;
a first obtaining unit that obtains a input search word input by a user;
a second obtaining unit that obtains a search condition relating to a notational form of the input search word;
a first converting unit that converts the input search word to a normal-form search word based on the normal form character and the variant form character that are brought into correspondence by the first storage unit; and
a searching unit that searches the character in the document by comparing the normal-form search word and the search condition with the normal form character and the rule identification information, respectively, which are brought into correspondence by the third storage unit.

2. The apparatus according to claim 1, wherein the first storage unit stores rule identification information of each of conversion rules in correspondence with the normal form character, when a plurality of the conversion rules are used in conversion of the variant form character to the normal form character.

3. The apparatus according to claim 1, further comprising:
a third obtaining unit that obtains different conversion rules;
a second converting unit that converts the variant form character to the normal form character in accordance with the conversion rules obtained by the third obtaining unit; and
a first registering unit that registers with the first storage unit, in correspondence with one another, the variant form character before conversion performed by the second converting unit, the normal form character after the conversion performed by the second converting unit, and the rule identification information of the conversion rules used when the second converting unit performs the conversion to the normal form character.

4. The apparatus according to claim 3, wherein the third obtaining unit obtains a plurality of conversion rules that correspond to the same character.

5. The apparatus according to claim 3, wherein
the third obtaining unit obtains a first rule that is used to convert a predetermined variant form character to another variant form character, and a second rule that is used to convert the variant form character to the normal form character; and
the first registering unit registers with the first storage unit the rule identification information of each of the first rule and the second rule in correspondence with the normal form character, when the second converting unit converts the variant form character to the normal form character in accordance with the first rule and the second rule.

6. The apparatus according to claim 1, further comprising:
a fourth obtaining unit that obtains the document;
a second registering unit that registers the document obtained by the fourth obtaining unit with the second storage unit;
a first dividing unit that divides the document obtained by the fourth obtaining unit and obtains the character;
a third converting unit that converts the character obtained by the first dividing unit to the normal form character, based on the variant form character and the normal form character that are brought into correspondence with each other by the first storage unit; and
a third registering unit that registers with the third storage unit, in correspondence with one another, the normal form character obtained by the third converting unit, the rule identification information that is brought into correspondence with the variant form character and the normal form character by the first storage unit, the document identification information obtained by the fourth obtaining unit, and location information of the character obtained by the first dividing unit.

7. The apparatus according to claim 1, wherein the third storage unit stores a gram which is a character string containing n characters as the normal form character.

8. The apparatus according to claim 7, further comprising:
a second dividing unit that divides the search word obtained by the first obtaining unit into the gram, wherein the searching unit performs a search by using the gram.

9. A document searching apparatus comprising:
an obtaining unit that obtains a plurality of conversion rules that are used for conversion of a notational form of a character;
a first converting unit that converts a variant form character, which is a character of a different form from a normal form that is a predetermined notational form, to a normal form character which is a character of the normal form in accordance with the conversion rules obtained by the obtaining unit;
a first storage unit that stores, in correspondence with one another, the variant form character, the normal form character, and rule identification information that is used to identify the conversion rules applied to the conversion to the normal form character;
a second storage unit that stores a document that is a search target;
a dividing unit that divides the document stored by the second storage unit and obtains a character;
a second converting unit that converts the character obtained by the dividing unit to the normal form character in accordance with the variant form character and the normal form character that are brought into correspondence with each other by the first storage unit; and
a third storage unit that stores, in correspondence with one another the normal form character obtained by the second converting unit, the rule identification information, document identification information that is used to identify the document, and location information of the character.

10. A document searching method comprising:
obtaining a input search word input by a user;
obtaining a search condition relating to a notational form of the input search word;
converting the input search word to a normal-form search word which is a word of a normal form that is a predetermined notational form, based on a normal form character which is a character of the normal form and a variant form character which is a character of a notational form different from the normal form, that are brought into correspondence by a first storage unit that stores, in correspondence with one another the normal form character, the variant form character, and rule identification information that is used to identify a conversion rule applied to conversion of the variant form character to the normal form character; and
comparing the normal form character and the rule identification information that are brought into correspondence by a second storage unit with the normal-form search word and the search condition, respectively, that are obtained in a converting, the second storage unit storing, in correspondence with one another, the normal form character that corresponds to a character included in a search target document, the rule identification information, document identification information that is used to identify the search target document, and location information of the character included in the search target document, and thereby searching the character in the search target document.

11. A document searching method comprising:
obtaining a plurality of conversion rules that are used to convert a notational form of a character;
converting a variant form character which is a character of a notational form different from a normal form that is a predetermined notational form, to a normal form character which is a character of the normal form based on the conversion rules;
registering with a first storage unit, in correspondence with one another the variant form character, the normal form character, rule identification information that identifies the conversion rules that are used for conversion to the normal form character in the converting;
registering a search target document with a second storage unit;
dividing the search target document stored by the second storage unit to obtain a character;
converting the character to the normal form character, based on the variant form character and the normal form character that are brought into correspondence by the first storage unit; and
registering with a third storage unit, in correspondence with one another, the normal form character, the rule identification information, document identification information of the search target document, and location information of the characters included in the search target document.

12. A computer program product having a computer readable medium including programmed instructions for performing a search process of a document, wherein the instructions, when executed by a computer, cause the computer to perform:
obtaining a input search word input by a user;
obtaining a search condition relating to a notational form of the input search word;
converting the input search word to a normal-form search word which is a word of a normal form that is a predetermined notational form, based on a normal form character which is a character of the normal form and a variant form character which is a character of a notational form different from the normal form, that are brought into correspondence by a first storage unit that stores, in correspondence with one another the normal form character, the variant form character, and rule identification information that is used to identify a conversion rule applied to conversion of the variant form character to the normal form character; and
comparing the normal form character and the rule identification information that are brought into correspondence by a second storage unit with the normal-form search word and the search condition, respectively, that are obtained in a converting, the second storage unit storing, in correspondence with one another, the normal form character that corresponds to a character included in a search target document, the rule identification information, document identification information that is used to identify the search target document, and location information of the character included in the search target document, and thereby searching the character in the search target document.

13. A computer program product having a computer readable medium including programmed instructions for performing a search process of a document, wherein the instructions, when executed by a computer, cause the computer to perform:
obtaining a plurality of conversion rules that are used to convert a notational form of a character;
converting a variant form character which is a character of a notational form different from a normal form that is a predetermined notational form, to a normal form character which is a character of the normal form based on the conversion rules;
registering with a first storage unit, in correspondence with one another the variant form character, the normal form character, rule identification information that identifies the conversion rules that are used for conversion to the normal form character in the converting;
registering a search target document with a second storage unit;
dividing the search target document stored by the second storage unit to obtain a character;
converting the character to normal form character, based on the variant form character and the normal form character that are brought into correspondence by the first storage unit; and
registering with a third storage unit, in correspondence with one another, the normal form character, the rule identification information, document identification information of the search target document, and location information of the characters included in the search target document.
